(19) United States
(12) Patent Application Publication
(10) Pub. No.: US 2004/0163197 A1
(43) Pub. Date: Aug. 26, 2004

(54) Applicator assembly for coating fasteners

(76) Inventors: William T. Mead, Long Beach, CA (US); Jorgge A. Millan, Lawndale, CA (US)

Correspondence Address: LOUIS L. DACHS, 1794 PALISADES DRIVE, PACIFIC PALISADES, CA, 90272, US

(21) Appl. No.: 10/373,449

(22) Filed: Feb. 24, 2003

(51) Int. Cl. B05C 17/02; B05C 17/00

(52) U.S. Cl. 15/230.11; 15/244.1; 492/13; 492/19

(57) ABSTRACT

A coating applicator assembly is disclosed for coating fasteners ends protruding from a surface of a structure, the fasteners extending a specific distance above the surface. In detail, the applicator assembly includes a handle. A coating member made from open celled compressible foam having a coating transfer surface in a generally W shape is attached to the handle. Preferably, the central V of the W shaped surface has an included angle of between 40 and 50 degrees and a depth of between 65 and 85 percent of the specific distance and the outer surfaces of the W shaped surface extending outward at an angle of between 40 and 50 degrees and the depth of coating member is at least 4 times the depth of the central notch.

### BACKGROUND OF THE INVENTION

1. Field of the Invention

The invention relates to the field of paint applicators and, in particular, to an improved applicator for coating the ends of fasteners protruding from structures.

2. Description of Related Art

In aircraft manufacture most structural elements are joined with fasteners. For corrosion protection, the surfaces of these structural elements are coated with a corrosion inhibiting coating. After assembly, the structural elements must also have the fastener ends (with retaining nuts attached) coated corrosion inhibiting coatings. Spraying on coatings can be used. However, the corrosion inhibiting coatings typically contain chromium compounds and the use of such sprays may cause environmental problems. Brushes can be used, but there use is time consuming. Thus the use of roller applicators becomes one of most effective methods from both environmental and time considerations.

However, prior art roller designs have not been totally effective. A straight roller will not completely cover the fasteners, especially if they are in rows. U.S. Pat. No. 5,410,773 “Pipe Paint Roller” by 1. H. Forkner discloses rollers having a U and square shaped notches. These shapes failed to adequately cover in just one pass. In fact, a lot of excess material had to be deposited on the surrounding surfaces before full coverage of the fasteners was accomplished. U.S. Pat. No. 2,929,089 “Paint Applicator For Corners” by W. L. Hall disclosed a roller for corners, with a 90 degree V shaped notch. Tests of this design were also unsuccessful. One of the problems was the shape outer edge collapsed under pressure causing two much of the coating to be deposited on the adjacent surfaces.

Thus, it is a primary object of the invention to provide a coating applicator for covering the ends of fasteners protruding from a surface.

It is another primary object of the invention to provide a coating applicator for covering the ends of fasteners protruding from a surface that covers the ends in one pass.

It is a further object of the invention to provide a coating applicator for covering the ends of fasteners protruding from a surface that covers the ends in one pass while applying a minimum amount of coating material to the adjacent surfaces.

### SUMMARY OF THE INVENTION

The invention is an applicator assembly for coating fasteners ends protruding from a surface of a structure, the fasteners extending a specific distance above the surface. In general terms, the applicator assembly includes a handle to which a coating member is attached made from open celled compressible foam having a coating transfer surface in a generally W shape. In on embodiment the handle includes an axle. A drum is rotatably mounted to the axle. The coating member is in the form of a ring mounted to the drum, the peripheral surface of the ring having the W shape. This embodiment is suitable for coating rows of fasteners. In a second embodiment, the coating member is in the form of a block of foam attached directly to the end of the handle. This configuration is suitable for fasteners located in a corner, where it is not possible to “roll” over the fastener end with a roller.

Preferably, the central notch of the W shape has and included angle δ of between 40 and 50 degrees. The depth of the notch is between 65 and 85 percent of the specific distance the fastener protrudes from the strucure. and the outer surfaces of the W shaped surface extending outward at an angle of between 40 and 50 degrees. The total depth of the coating member must be at least 4 times the depth of central notch. Preferably, the foam is open celled having a density of between 2 and 3 pounds per cubic foot. During coating, such a configuration will allow the coating member to deform sufficiently to completely engulf the fastener end and nut insuring that the imbibed coating material completely coats the fastener end and nut

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

### BRIEF DESCRIPTION OF THE DRAWINGS

FIG. 1 is an exploded view of the roller version of the applicator assembly.

FIG. 2 is a cross-sectional view of the assembly illustrated in FIG. 1 taken along the line 2-2.

FIG. 3 is a cross-sectional view of the assembly illustrated in FIG. 1 taken along the line 3-3

FIG. 4 is a is a view of the assembly shown in FIG. 1 applying a coating on a fasteners extending out of the surface of a structure.

FIG. 5 is a top view of the assembly shown in FIG. 1 applying a coating to a series of fasteners protruding from a structure.

FIG. 6 is a perspective view of a second embodiment applying a coating to a fastener in a corner of a structure.

### DESCRIPTION OF THE PREFERRED EMBODIMENT

Referring to FIGS. 1-3, the first embodiment of the coating applicator is in the form of a roller assembly, generally designated by numeral 10, The roller assembly includes a U shaped support frame 12 having a center leg 14 connected at one end to a side leg in the shape of a rod 16 acting as an axle. The rod 16 includes a flange 20 and a threaded end 18. A roller member 22 is rotatably mounted on the rod 16 retained thereon by flange 20 and a nut 24 engaging the threaded end 18. The roller member 22 includes a sleeve 26 having a hole 27 through which the rod 16 extends. Bonded to the exterior of the sleeve 26 is a foam coating applicator 28, which will be subsequently discussed in detail. Also attached to the center leg is a second side leg 32 which bends 90 degrees at its middle portion 34 and terminates in a threaded end 36. A handle 38 having an internally threaded end 40 is attached thereby to the threaded end 36. Thus the roller assembly so far described is conventional in design and other methods of attachment of the roller member can be used.

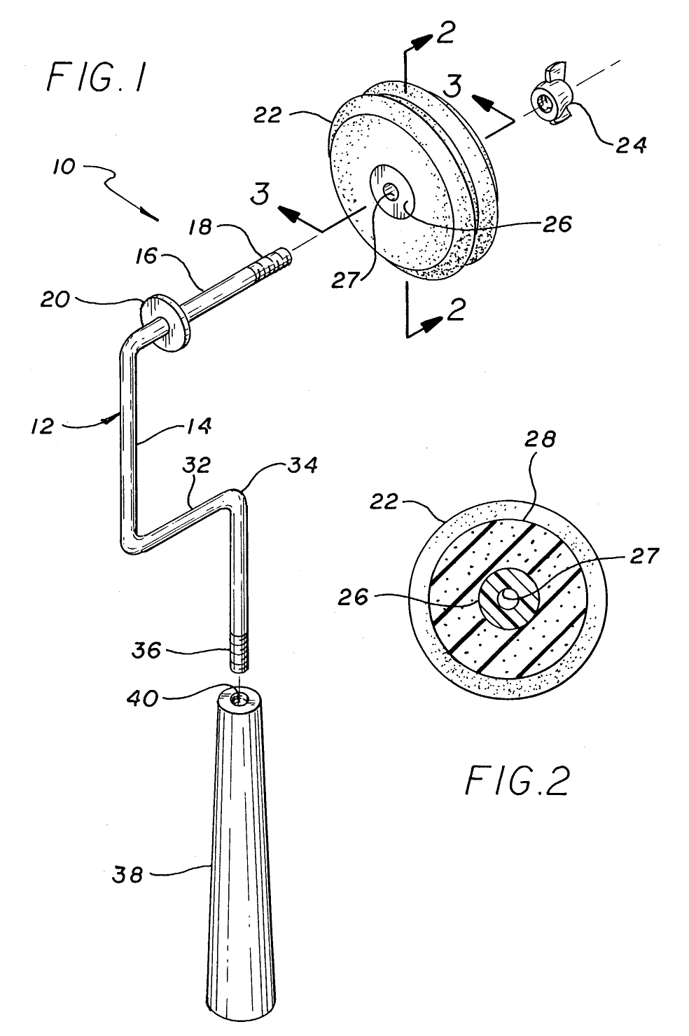

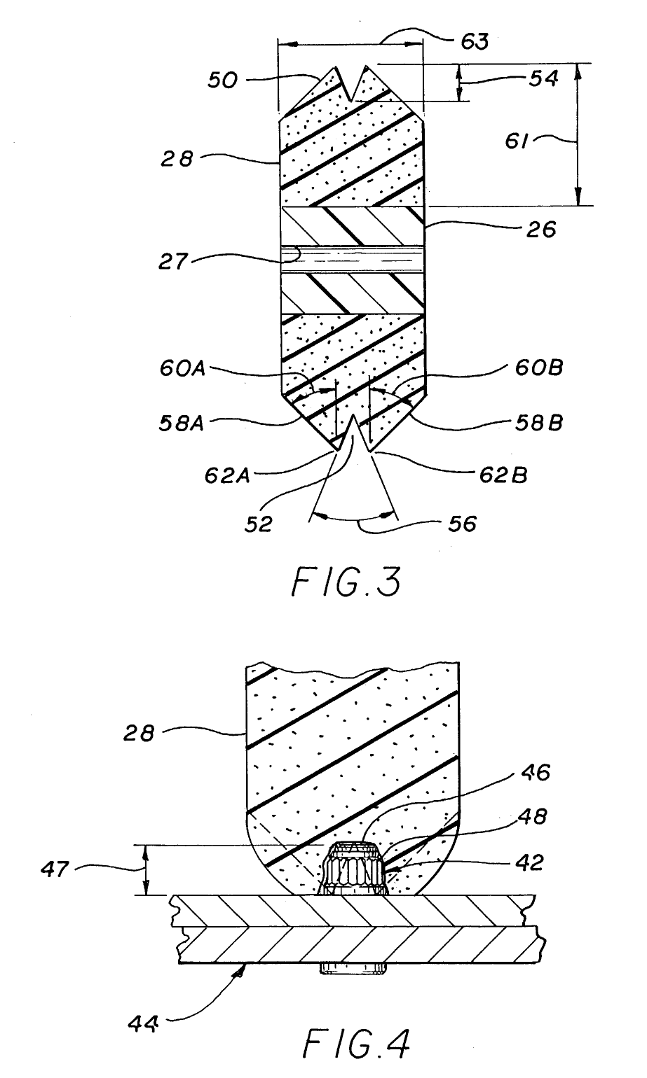

Particularly referring to FIGS. 2 and 3, the foam coating applicator 28 is designed to easily imbibe the coating material and coat fasteners 42 installed in structures such as plate assembly 44. The fastener ends 46 protrude out of the plate assembly 44 with a height 47 and are secured by nuts 48. In order to properly coat the fastener ends 46 with a minimum of coating material, the peripheral end 50 of the foam coating applicator 28 has a W shape. The center V shaped notch 52 has a depth 54 and an included angle 56. The outer sides 58A and 58B are at acute angles 60A and 60B, respectively, leaving only small contact edges 62A and 62B.

In order to insure that the fastener ends 46 are properly coated in a one or two passes of the roller assembly 10, the applicator 28 should have the following dimensions:

1. Depth 54 of groove 52 is between 60 to 70 percent of fastener height 47;

2. Angle 56 is between 40 and 50 degrees;

3. Angles 60A and 60B between 40 and 50 degrees; and

4. Depth 61 of coating applicator is greater than 4 times the depth of the 54 of the groove 52.

5. Width 63 of coating applicator is not critical, but must be sufficient to prevent collapse upon application of the coating material.

The foam should be open celled foam having a density of between 2 to 3 pounds per cubic foot. As previously stated, during coating, such a configuration will allow the coating member to deform sufficiently to completely engulf the fastener end and nut insuring that the imbibed coating material completely coats the fastener end and nut. Suitable foam is sold under the trade name Artilon®, manufactured by Youngbo America Incorporated, Huntington Beach, Calif.

As illustrated in FIGS. 4 and 5, when the roller 10 is pressed down over the fastener ends 46, the roller applicator 28 flattens such the notch 52 deforms about the fastener end 46 causing any imbibed coating material to completely coat the fastener end. Because only the flattened contact edges 62A and 62B remain in contact with the plate 44 between fasteners little coating material is deposited between the fasteners as indicated by numeral 64 in FIG. 5. Tests have demonstrated that's other shapes, such as notch or semicircle or 90 V do not work.

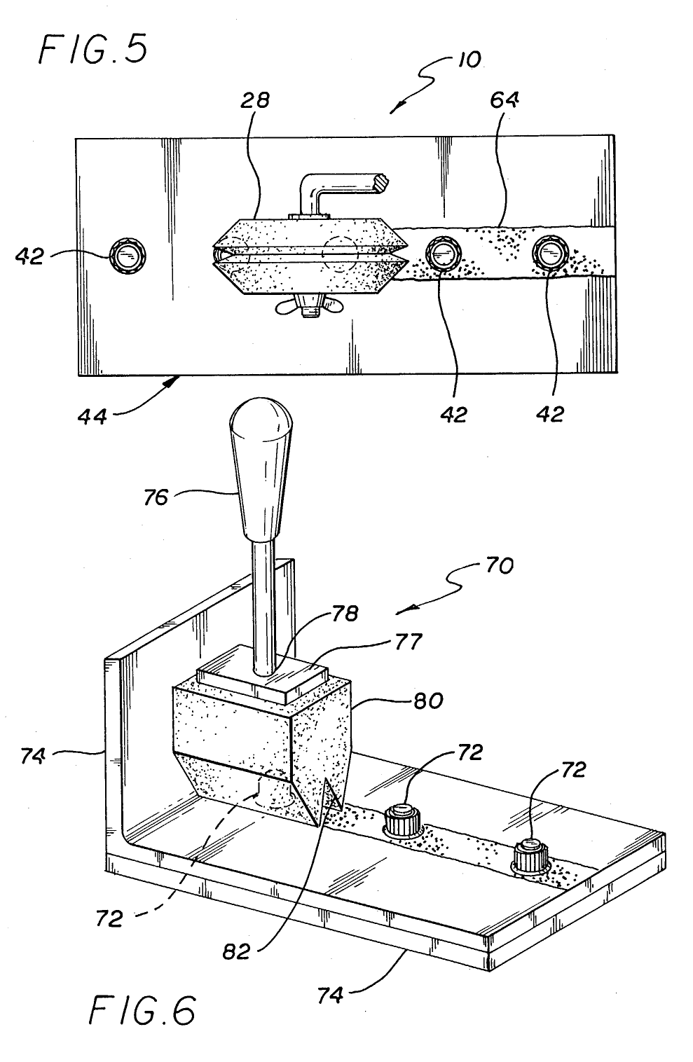

A second embodiment is illustrated in to FIG. 6. Here the applicator assembly, generally indicated by numeral 70, is shown coating a fastener 72 in a corner of a structure 74. The applicator assembly 70 includes a simple handle 76 having a plate 77 at end 78. A block of foam 80 with a W shaped surface 82 is bonded to the plate 77. It is obvious that this applicator assembly 70 is ideally suited for such situations where a roller assembly could not be effectively used.

While the invention has been described with reference to particular embodiments, it should be understood that the embodiments are merely illustrative, as there are numerous variations and modifications, which may be made by those skilled in the art. Thus, the invention is to be construed as being limited only by the spirit and scope of the appended claims.

### INDUSTRIAL APPLICABILITY

The invention has applicability to the paint industry.

1. A coating applicator assembly for coating fasteners ends protruding from a surface of a structure, the fasteners extending a specific distance above the surface, the applicator assembly comprising:
a handle;
a coating member made from open celled compressible foam having a coating transfer surface in a generally W shape.

2. The coating applicator assembly as set forth in claim 1, wherein the central with the central notch of said W shape having and included angle of between 40 and 50 degrees and a depth of between 65 and 85 percent of the specific distance and the outer surfaces of the W shaped surface extending outward at an angle of between 40 and 50 degrees and the depth of coating member is at least 4 times the depth of the central notch.

3. The coating applicator assembly as set forth in claim 2 wherein said foam is and open celled foam having a density of between 2 and 3 pounds per cubic foot.

4. The coating applicator assembly as set forth in claim 1 wherein:
said handle includes an axle;
a drum rotatably mounted to said axles; and
said coating member in the form of a ring mounted to said drum, the peripheral surface of said drum having said W shape.

5. The coating applicator assembly as set forth in claim 4, wherein the central with the central notch of said W shape having and included angle of between 40 and 50 degrees and a depth of between 65 and 85 percent of the specific distance and the outer surfaces of the W shaped surface extending outward at an angle of between 40 and 50 degrees and the depth of coating member is at least 4 times the depth of the central notch.

6. The coating applicator assembly as set forth in claim 5 wherein said foam is and open celled foam having a density of between 2 and 3 pounds per cubic foot.
